(19) United States
(12) Patent Application Publication
(10) Pub. No.: US 2025/0146595 A1
(43) Pub. Date: May 8, 2025

(54) Linear Actuator for Actuating a Process Valve

(71) Applicant: Robert Bosch GmbH, Stuttgart (DE)

(72) Inventors: Markus Kubacki, Wuerzburg (DE); Gottfried Hendrix, Gemuenden (DE); Alexandre Orth, Hettstadt (DE)

(21) Appl. No.: 18/835,579

(22) PCT Filed: Feb. 1, 2023
(86) PCT No.: PCT/EP2023/052439

§ 371 Date: Aug. 2, 2024

(30) Foreign Application Priority Data
Feb. 7, 2022 (DE) 10 2022 201 228.3

(51) Int. Cl. F16K 31/122; F15B 15/14

(52) U.S. Cl. CPC F16K 31/1221; F15B 15/1423

(57) ABSTRACT

A linear actuator for linear actuation of a process valve which has a housing is disclosed. An electronic control unit, at least one electric drive unit, and at least one hydraulic drive are located in the housing. The hydraulic drive includes at least one hydraulic cylinder with a piston and a piston rod. The piston rod extends outwardly through an opening in the housing. The hydraulic drive is configured to convert an electric drive power of the electric drive unit into a hydraulic driving force which generates a linear movement of the at least one hydraulic cylinder in a first direction. A linear movement of the piston of the hydraulic cylinder in a second direction opposite to the first direction is generated by a restoring force on the piston rod, which restoring force acts on the piston rod outside the housing.

The present invention relates to a linear actuator for actuating a process valve and a system comprising the linear actuator.

### BACKGROUND OF THE INVENTION

For petroleum or natural gas conveying systems operated at deep ocean depths, process valves are used by means of which the flow rate of the medium being conveyed can be controlled or blocked. Said process valves are actuated by means of electro-hydraulic actuators, such as a hydrostatic linear actuator. This can comprise a hydraulic cylinder having one or more springs for displacing the piston of the hydraulic cylinder to a predetermined position if the hydraulic drive fails. The process valve is thereby set to a safe position in the event of a fault.

DE 10 2020 200 263 A1 shows a hydrostatic linear actuator that exerts a pulling force on a safety-relevant component in an emergency, wherein the pulling force is first generated by an expanding emergency spring. In a last part of the movement, a hydraulic accumulator is connected via a path-dependent control, the pressurizing medium of which is conveyed into a cylinder space acting on a piston to which the component is coupled.

The disadvantage of a linear actuator according to DE 10 2020 200 263 A1 is the increased weight thereof due to the safety elements integrated in the actuator (spring systems, additional hydraulic components). This makes it difficult to replace a faulty linear actuator at great depths by means of a Remote Operated Vehicle (ROV).

### DISCLOSURE OF THE INVENTION

According to the invention, a linear actuator for actuating a process valve and a system comprising the linear actuator having the features of the independent claims are proposed. Advantageous configurations are the subject-matter of the dependent claims and the following description.

The invention provides a compact and simple linear actuator requiring only a few elements for actuating a process valve and therefore has a low weight. The linear actuator can be coupled to a safety device by means of a standard interface.

The linear actuator according to the invention for linear actuation of a process valve comprises a housing in which an electronic control unit, at least one electric drive unit, and at least one hydraulic drive are disposed. The hydraulic drive comprises at least one hydraulic cylinder having a piston and a piston rod. The piston rod extends outwardly through an opening of the housing. The hydraulic drive is configured to convert an electric drive power of the electric drive unit into a hydraulic drive force for producing linear movement of the piston of the at least one hydraulic cylinder in a first direction. A linear movement of the piston of the hydraulic cylinder in a second direction opposite the first direction is generated by a restoring force on the piston rod acting on the piston rod outside the housing of the piston, and in particular not by a spring force of a mechanical spring of the linear actuator. In particular, no hydraulic drive force is applied to the opposite side of the piston to displace said piston in the second direction.

Preferably, the housing serves as a tank for the hydraulic drive and is filled with a pressure fluid. The pressure fluid is preferably also used to resist external pressure acting on the linear actuator, as well as to protect against corrosion and to lubricate the elements of the safety device. For example, the pressure fluid can be hydraulic oil.

Preferably, the hydraulic drive comprises at least one pump and at least one hydraulic cylinder. The electric drive unit can be an electric motor for driving the pump via a common shaft. The hydraulic cylinder is preferably implemented as a synchronous cylinder. Preferably, the pump conveys pressure fluid from an interior space of the linear actuator into a working space of the hydraulic cylinder via a pipeline. Particularly preferably, a check valve is disposed downstream of the pump. The pressure fluid conveyed into the work space causes a hydraulic drive force on the piston, which creates a movement of the piston rod of the hydraulic cylinder in a first direction. In a second direction opposite the first direction, the piston rod of the hydraulic cylinder is displaced by a restoring force on the piston rod acting on the piston rod outside the housing and being greater than the instantaneous driving force. The driving force should then preferably be as low as possible or zero. To this end, the electric drive unit can first be switched off and subsequently the pressure fluid can be drained from the working space of the hydraulic cylinder or pushed out by the reverse movement of the piston.

Preferably, the linear actuator comprises at least one relief valve configured to reduce the hydraulic drive force. The relief valve is disposed in a pipeline between the working space of the hydraulic cylinder and the interior space of the linear actuator. Preferably, said valve is an electrical relief valve that can be opened and closed by means of an actuating current/voltage. Particularly preferably, the relief valve is closed in the energized state or open when deenergized (NO, normally open). As long as the pump conveys pressure fluid into the working space of the hydraulic cylinder to build up the hydraulic drive force, the relief valve can be actuated so as to be in a closed position. To reduce the hydraulic drive force, the relief valve can be opened by switching off the drive current so that the pressure fluid can drain from the working space of the hydraulic cylinder into the interior space of the linear actuator. The relief valve is preferably a normally open (NO) valve that opens when the control voltage drops. Because the relief valve is open when deenergized, the hydraulic driving force is automatically reduced in the event of a failure of the controller, thereby increasing the safety of the system.

Preferably, the linear actuator comprises at least one variable restrictor valve that is configured to control the reduction of the hydraulic drive force. Preferably, the variable restrictor valve is disposed upstream of the relief valve in the pipeline between the working space of the hydraulic cylinder and the interior space of the linear actuator. Preferably, an opening cross section of the restrictor valve and thus a flow through the restrictor valve can be controlled. Particularly preferably, the variable restrictor valve is an electrical valve, the cross section of which can be varied by means of an actuating current or an actuating voltage. The electronic control unit can include predetermined values/characteristics for the actuating signal, by means of which different force reduction characteristics can be set. It is also possible that the reduction of the hydraulic driving force is controlled. For example, the piston position of the hydraulic cylinder can be measured and the opening cross-section of the restrictor valve adjusted such that the piston always occupies the desired position during the reduction of the force. The restrictor valve is preferably a normally open (NO) valve that opens when the control voltage drops. Because the restrictor valve is open when deenergized, the reduction of the hydraulic drive force is not hindered in the event of failure of the controller, thereby increasing the safety of the system.

Preferably, the linear actuator also comprises a pressure compensation device configured to cause pressure to be equalized between an environment and an interior space of the linear actuator. Preferably, the pressure compensation device is a diaphragm accumulator or a bladder accumulator that has fluid communication with a housing opening. The pressure compensation device is particularly advantageous when using the linear actuator in underwater applications. Particularly preferably, the pressure compensation device is a bladder accumulator. The bladder accumulator can be implemented having a flexible wall enclosing a specifiable bladder accumulator volume and able to be displaced axially and radially in response to the pressure prevailing in the interior of the accumulator. The flexible wall of the bladder reservoir may, for example, be made of an elastomer and are designed to be fluid-tight and resistant to contact with sea water under high pressure.

Particularly preferably, the pressure compensation device is configured to adjust a pressure in the interior space of the linear actuator in a range between ambient pressure and 10 bar above ambient pressure. This can be done, for example, by means of a spring preloading a membrane attached to the pressure compensation device. By means of the preloading force of the spring, the pressure in the interior space of the pressure compensation device can be set to a desired value above the ambient pressure.

Preferably, the linear actuator also comprises at least one mechanical interface by means of which a safety device can be connected to the linear actuator. Preferably, the mechanical interface can include a quick-release fastener, in particular a rotating fastener (i.e., a connection that can be fastened by rotating one of the components involved, preferably by a maximum of 360°, a maximum of 180°, a maximum of 90°, or a maximum of) 45°, e.g., a bayonet fastener or a quick-release fastener in accordance with EN ISO 13628-8, “Linear (push) interface”, type A or type C. Said quick-release fastener comprises a flange on one side having recesses disposed about a first shaft. Jaw-shaped protrusions of a second shaft of an opposite side can be inserted axially into the recesses of the flange, and the two sides of the quick-release fastener can be connected to each other by rotating the second shaft 45° in a clockwise direction. By rotating the second shaft 45° clockwise, the jaw-shaped protrusions thereof axially and radially abut the flange of the first shaft so that a positive connection is made between the two sides of the quick-release fastener.

The safety device can comprise one side of the quick-release fastener described above, and the linear actuator can comprise the second side of the quick-release fastener.

The safety device can comprise a housing and a piston rod, wherein the piston rod is linearly displaceably supported in the housing and connectable to a process valve. The safety device can also comprise a piston connected to the piston rod, as well as at least one spring clamped between the piston and an end face of the housing. This means that the piston rod with the piston is retained by the spring force in a predetermined position (end position) as long as no hydraulic driving force of the linear actuator acts on the piston rod against and greater than the spring force. Preferably, a process valve connected to the safety device is in a safe position at said end position of the piston rod. Preferably, the safe position is a closed position of the process valve.

Accordingly, the safety device serves to accelerate the reduction of the hydraulic driving force of the linear actuator in the event of a fault, for example in the event of a power failure, and to bring the process valve into a safe position in a short time.

The decoupling of the safety device from the linear actuator allows the weight thereof to be reduced such that said actuator can be replaced by means of an ROV by means of the mechanical interface. This can be done without the need to remove or open the safety device. This results in significant simplification in the maintenance and assembly of the linear actuator, especially at great depths.

Particularly preferably, the linear actuator comprises a hydraulic circuit for loading at least one spring of the safety device. This allows the process valve to open by means of the linear actuator without having to overcome the spring force of the safety device. A lower hydraulic drive force of the linear actuator is thus required. The safety device can have a separate mechanical interface, for example, an additional shaft, via which a force can be applied to the spring, to preload the spring. A piston rod of a hydraulic cylinder can engage said shaft.

The hydraulic circuit for loading the at least one spring of the safety device preferably comprises a hydraulic cylinder having a first cylinder space connected to the pump via a first pipeline and to a relief valve via a second pipeline. In the second cylinder space of the hydraulic cylinder, pressure fluid can be locked in via a check valve. In order to load the at least one spring of the safety device, pressure fluid is first conveyed into the first cylinder space, whereby the piston rod of the hydraulic cylinder moves towards the safety device and exerts a force on the separate mechanical interface of the safety device. When the desired loading of the spring is achieved, the check valve to the second cylinder space can be closed and thus the position of the piston rod can be fixed. Deviations from the set piston rod position due to the release of pressure fluid from the second cylinder space can be offset by the permanent connection of the first cylinder space to the pump. If a power failure occurs, both the relief valve on the first cylinder space and the shut off valve on the second cylinder space open so that no more force is transferred from the hydraulic cylinder to the spring. Thus, the function of the safety device is also ensured with a separate pre-load of the spring.

According to a preferred embodiment, the at least one hydraulic cylinder comprises three cylinder chambers, one of which is hermetically closed, such that a vacuum forms therein upon movement of the piston rod. Preferably, the hydraulic cylinder is synchronized cylinder, on which a third, hermetically closed cylinder chamber is additionally disposed or can be generated at an outer end of the piston rod of the synchronized cylinder. This can mean that said cylinder chamber is formed or limited at least in part by the piston rod. In particular, a volume of the hermetically closed cylinder chamber can be variable by means of the piston rod, and can also be zero in a stop position of the piston rod. A volume change of the third cylinder chamber when the piston is moved advantageously corresponds to a volume change of the portion of the piston rod outside of the housing. This allows for movement of the piston rod without volume change of the pressure compensation device, i.e. the oscillating volume of the hydraulic cylinder can be reduced.

Preferably, the cylinder chamber exposed to vacuum is a vacuum bushing or vacuum sleeve. It is possible that the hermetically closed cylinder chamber is embodied as a separate component.

Preferably, the linear actuator further comprises at least one sensor configured to detect the position of the linear actuator and an indicator device configured to indicate the position of the linear actuator on an outer side of the housing thereof. Furthermore, the linear actuator can contain pressure sensors for monitoring the pressure within the individual chambers of the linear actuator. The indicator device can include a physical indicator (e.g., a moving arrow) indicative of the position of the linear actuator (e.g., the position of the piston or piston rod of the hydraulic cylinder) on the outer side of the housing. The physical indicator can be mechanically connected to the piston and/or piston rod of the hydraulic cylinder of the linear actuator. The indicator device can be used by an ROV and/or monitored via a camera.

The system according to the invention comprises a linear actuator for linearly actuating a process valve and at least one safety device as described above. The safety device is connected to the linear actuator by means of a mechanical interface, as described above.

Further advantages and configurations of the invention will emerge from the description and the accompanying drawings.

It is understood that the features specified hereinabove and those to be explained hereinafter can be used not only in the combination indicated in each case, but also in other combinations or on their own, without departing from the scope of the present invention.

The invention is illustrated schematically in the drawings on the basis of embodiment examples and is described hereinafter with reference to the drawings.

### DESCRIPTION OF THE DRAWINGS

FIGS. 1a and 1b show a preferred embodiment of a linear actuator according to the invention, respectively in spatial exterior view and in longitudinal section;

FIG. 2 shows a hydraulic circuit diagram of a linear actuator according to a preferred embodiment of the invention;

FIG. 3 shows a hydraulic circuit diagram of a linear actuator according to a further preferred embodiment of the invention;

FIG. 4 shows one example of a mechanical interface between a linear actuator and a safety device according to a preferred embodiment of the invention in longitudinal section; and

FIG. 5 shows a linear actuator and a safety device according to a preferred embodiment of the invention in an exterior spatial view.

### DETAILED DESCRIPTION OF THE DRAWINGS

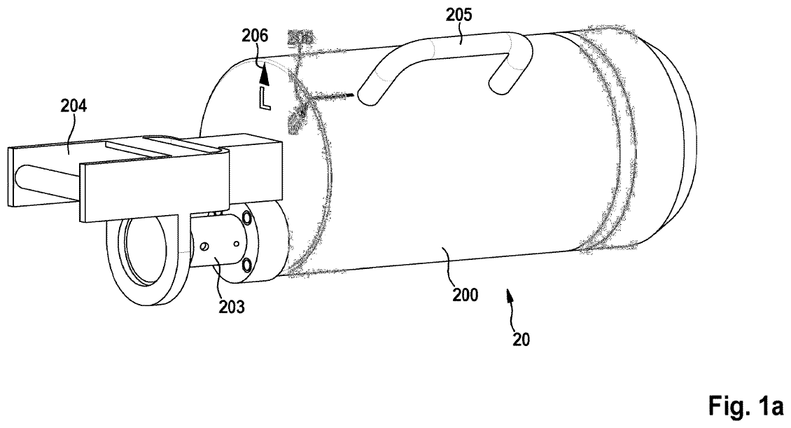

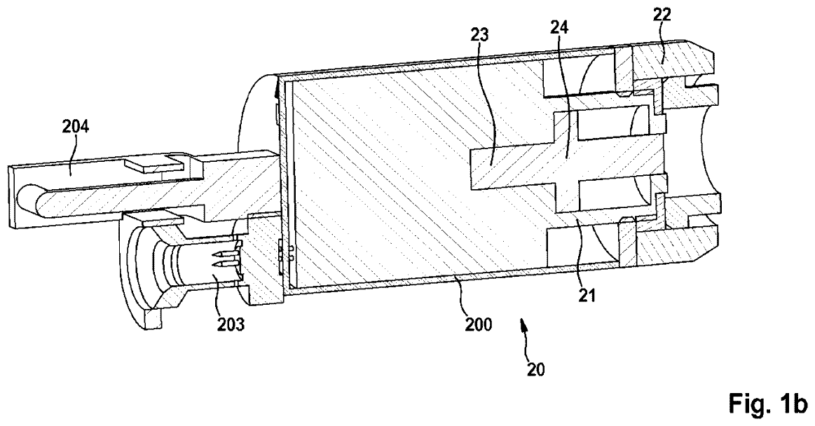

FIGS. 1a and 1b show a preferred embodiment of the linear actuator 20 according to the invention. In FIG. 1a, the linear actuator 20 is shown in an external spatial view. Exemplary standardized handles 204, 205 for assembly/disassembly of the linear actuator 20 by means of an ROV are mounted on the cylindrical surface of the linear actuator housing 200 as well as on the front face on the left side thereof in the figure.

In addition, a plug connection 203 is located on the left end face of the linear actuator 20, to which the current and signal supply of the linear actuator 20 is connected. A indicator device 206 indicative of the position of the linear actuator 20 can be seen on the front face of the linear actuator 20.

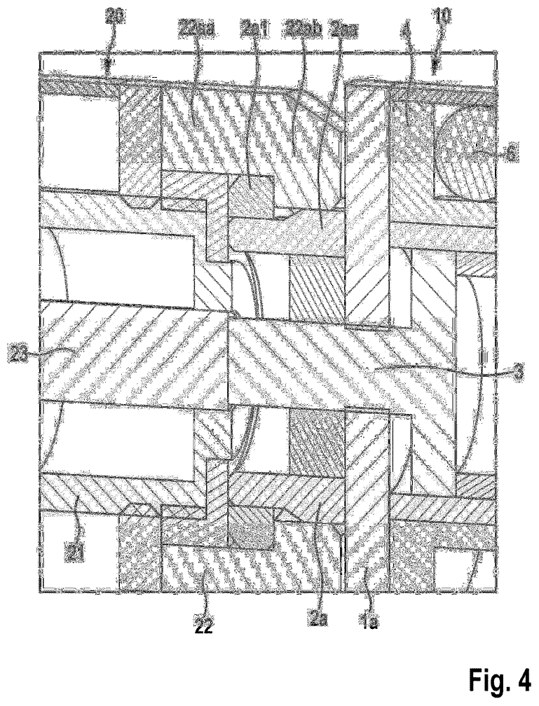

FIG. 1b shows the linear actuator in a longitudinal section. An electronic control unit (not shown), an electric drive unit (not shown), and a hydraulic drive are disposed in the housing 200. The hydraulic drive comprises a pump (not shown) and a hydraulic cylinder 21. A piston rod 23 is disposed in the hydraulic cylinder 21 and is fixedly connected to a piston 24. The piston rod is displaceable to the right in the figure and then extends outside of the housing 200. In addition, the linear actuator 20 shown has a mechanical interface 22 to which a safety device can be coupled. The mechanical interface 22 is described in more detail below in connection with FIG. 4.

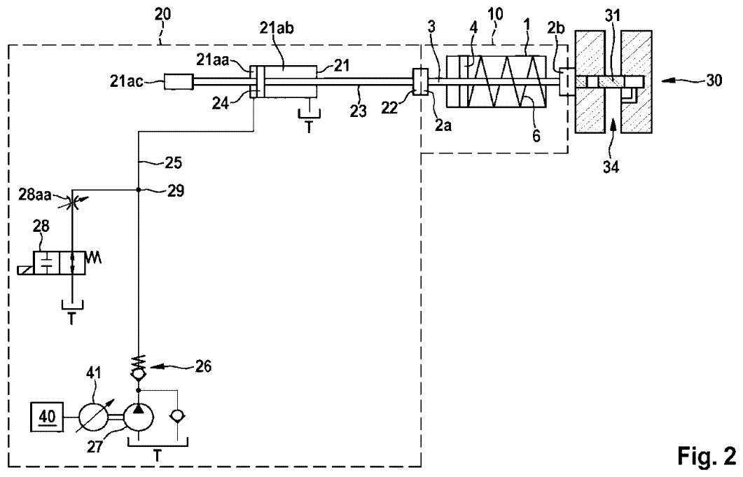

FIG. 2 shows a hydraulic circuit diagram of a linear actuator 20 according to a preferred embodiment of the invention. Shown are a linear actuator 20 and a safety device 10 connected to the linear actuator 20 by means of a mechanical interface 2a. For this purpose, the mechanical interface 2a of the safety device 10 is coupled to a corresponding interface 22 of the linear actuator 20. On an opposite side of the safety device 10 to the first interface 2a, a further interface 2b is disposed on the safety device 10 by means of which said device can be connected to a process valve 30. For coupling, the linear actuator 20 is attached to the safety device by means of interlocking interfaces 22, 2a and rotated by 45°, for example.

In addition to the interfaces 2a, 2b, the safety device 10 according to FIG. 2 contains a housing 1, in which is disposed an axially displaceable piston rod 3 having a piston 4 fixedly connected to the piston rod 3. A spring 6 is loaded between the piston 4 and an end face of the housing 1. The housing 1 of the safety device 10 can be filled with a pressure fluid.

The process valve 30 shown comprises a disc 31 that opens and closes a valve passage 34 as a result of movement of the piston rod 3 of the safety device 10.

The linear actuator 20 shown in FIG. 2 contains an electronic control unit 40 having, for example, analog and digital inputs and outputs and able to receive signals from pressure and position sensors (not shown) and to control the electrical and hydraulic drive. In addition, the linear actuator 20 comprises a pump 27 driven by an electric motor 41 and conveying pressure fluid from an interior space T of the linear actuator 20 via a pipeline 25 into a work space 21aa of a hydraulic cylinder 21.

The hydraulic cylinder 21 shown is implemented as a synchronous cylinder and comprises a piston rod 23 to which a piston 24 is attached. The piston 24 bounds the working space 21aa against a second cylinder space 21ab, which is hydraulically connected to the interior space of the linear actuator 20. In addition, the linear actuator 20 comprises a relief valve 28 also connected to the work space 21aa of the hydraulic cylinder 21 via the pipeline 25. FIG. 2 shows the position of the hydraulic cylinder 21 when the relief valve 28 is opened, wherein the work space 21aa has a minimum size, while the opposite cylinder space 21ab has a maximum size.

A hermetically closed cylinder chamber 21ac is disposed or generated at an outer end of the piston rod 23, in which a vacuum forms upon movement of the piston rod 23. A volume change of the cylinder chamber 21ac as the piston is displaced corresponds advantageously to a volume change of the portion of the piston rod outside of the housing, i.e. the oscillating volume of the hydraulic cylinder 21 can be reduced.

A check valve 26 is disposed between the pump 27 and the port 29 of the pressure relief valve 28 in the pipeline 25 and prevents the backflow of the pressure fluid into the pump 27 when the work space 21aa is depressurized. Also, upstream of the pressure relief valve 28 is a variable restrictor valve 28aa that can control an amount of the pressure fluid flowing from the work space 21aa. Preferably, an opening cross-section of the restrictor valve 28aa, and thus a flow through the restrictor valve 28aa, can be controlled. Particularly preferably, the variable restrictor valve 28aa is an electrical valve, the cross section of which can be varied by means of an actuating current or an actuating voltage. The electronic control device 40 can include predetermined values/characteristics for the actuating signal, by means of which different force reduction characteristics can be set. It is also possible that the reduction of the hydraulic driving force is controlled. For example, the piston position or the pressure in the hydraulic cylinder 21 can be adjusted and the opening cross-section of the restrictor valve 28aa can be adjusted such that the piston 24 takes on the desired position at all times during the reduction of force.

When the relief valve 28 is opened, the spring force of the spring 6 of the safety device 10 acts on the piston 4 thereof and displaces the piston rod 23 with the piston 24 via the piston rod 3 of the safety device 10 and the interface 2a, 22 between the safety device 10 and the linear actuator 20 until the work space 21aa has reached the minimum volume thereof. In this state shown in FIG. 2, the piston rod 3 with the piston 4 of the safety device 10 is in a predetermined position (end position) and the valve passage 34 of the process valve 30 is closed by the disc 31. The disc 31 of the process valve 30 is connected to the piston rod 3 of the safety device 10 by means of the interface 2b. By displacing the piston rod 3 in the direction of the spring force, the disc 31 closes off the valve passage 34.

If, on the other hand, the relief valve 28 is closed and pressure fluid is conveyed from the pump 27 into the work space 21aa, the force of the hydraulic cylinder 21 acts against the spring force of the spring 6 of the safety device 10 so that the spring 6 is loaded/compressed. The piston rods 23, 3 of the linear actuator 20 and safety device 10 move opposite the direction of the spring force and thus displace the connected disc 31 of process valve 30 such that valve passage 34 is opened (not shown).

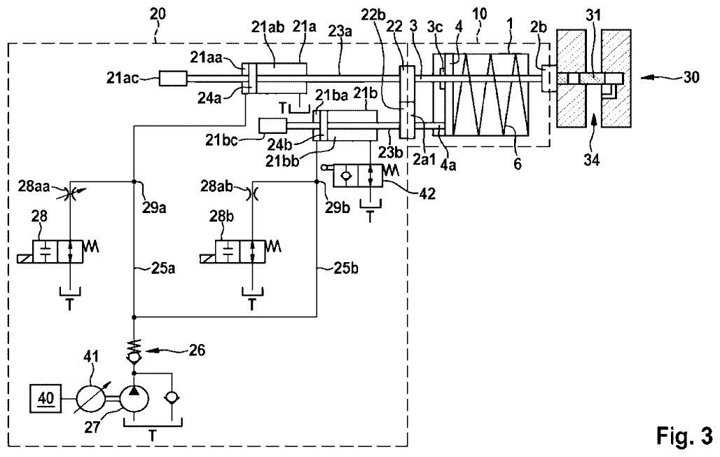

FIG. 3 shows a hydraulic circuit diagram of a linear actuator according to a further preferred embodiment of the system according to the invention. In this case, the linear actuator 20 contains, in addition to the elements described in FIG. 2, an additional hydraulic circuit for loading the spring 6 of the safety device 10. The piston 4 of the safety device 10 is not fixed, but is unidirectionally connected to the piston rod 3 of the safety device 10 via a driver 3c. This allows the piston 4 to be displaced and thus to preload the spring 6 independent of the movement of the piston rod 3 of the safety device 10.

The additional hydraulic circuit according to FIG. 3 comprises a hydraulic cylinder 21b having a first cylinder space 21ba connected to the pump 27 via a pipeline 25b. A relief valve 28b is connected to the first cylinder space 21ba via a port 29b. The second cylinder space 21bb of the hydraulic cylinder 21b is connected to a shut off valve 42 by means of which pressure fluid can be trapped within the second cylinder space 21bb.

The piston rod 23b of the hydraulic cylinder 21b acts via a mechanical interface 22b, 2al on a shaft 4a of the safety device 10, which in turn acts on the spring 6 via the piston 4. In the state shown in FIG. 3, the spring 6 is still fully relaxed and the piston 24b of the hydraulic cylinder is in the initial position.

To load the spring 6, pressure fluid is first conveyed into the first cylinder space 21ba, whereby the piston rod 23b is displaced towards the safety device 10 by means of the piston 24b and applies a force to the spring 6 of the safety device 10 via the shaft 4a and the piston 4. When the desired loading of the spring 6 is achieved, the check valve 42 to the second cylinder space 21bb can be closed and thus the position of the piston rod 23b can be fixed. Deviations from the set piston rod position due to the release of pressure fluid from the second cylinder space 21bb can be offset by the permanent connection of the first cylinder space 21ba to the pump 27.

If power is lost, both the relief valve 28b connected to the first cylinder space 21ba and the shut off valve 42 connected to the second cylinder space 21bb will open. Consequently, no force is transferred from the hydraulic cylinder 21b to the spring 6 anymore. Thus, the spring 6 can expand towards the Lino-actor 10 and displace the piston 4 to its end position (predetermined position). In this way, the piston 4 contacts the driver 3c of the piston rod so that the piston rod 3 is also displaced to the end position thereof and brings the process valve 30 to a safe position.

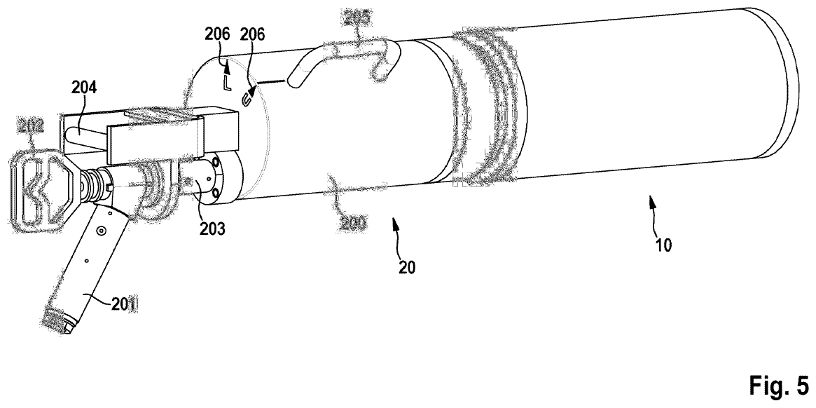

FIG. 4 shows one example of a mechanical interface between a linear actuator 20 and a safety device 10 according to a preferred embodiment of the invention in longitudinal section. On the right side of FIG. 5 is shown an excerpt of the safety device 10 showing parts of the piston rod 3, the piston 4 and the spring 6 as well as an end face 1a of the housing 1 facing the linear actuator 20 having the first mechanical interface 2a. The interface 2a is designed in accordance with EN ISO 13628-8 as a quick-release fastener (“linear (push) interface”, type A or type C). It comprises a first shaft 2aa, around which a flange 2ab is disposed with recesses (not shown). At this interface 2a, the linear actuator 20 is coupled by means of the interface 22, which is the counterpart of the quick-release. The section of the linear actuator 20 shown on the left side of FIG. 4 shows, in addition to the interface 22, a part of the hydraulic cylinder 21 facing toward the safety device 10 having the piston rod 23. The interface 22 of the linear actuator 20 comprises a second shaft 22aa having jaw-shaped protrusions 22ab engaging around the flange 2ab of the safety device 10. To connect the linear actuator 20 to the safety device 10, the jaw-shaped protrusions 22ab are pushed in the axial direction into the recesses (not shown) of the flange 2ab and engaged with the flange 2ab by rotating the linear actuator 20 by 45° in the clockwise direction. Thus, in the closed state of the quick-release 2a, 22 shown in FIG. 4, the jaw-shaped protrusions 22ab axially and radially abut the flange 2ab of the first shaft so that a positive connection of the two sides of the quick-release fastener 2a, 22 is made. Due to the connection by means of the quick-release fastener 2a, 22, the opposite ends of the piston rods 23, 3 of the linear actuator 20 and the safety device 10 are connected to each other by a force fit.

The quick-release fastener 2a, 22 allows the linear actuator 20 to be replaced by means of an ROV without the need to remove or open the safety device. This results in significant simplification in the maintenance and assembly of the linear actuator, particularly at great depths.

FIG. 5 shows a linear actuator 20 and a safety device 10 according to a preferred embodiment of the invention in an exterior spatial view. In the present figure, the linear actuator 20 and the safety device 10 are connected by means of the quick-release fastener 2a, 22, as shown in FIG. 4. Standardized handles 202, 204, 205 for assembly/disassembly of the linear actuator 20 by means of an ROV are attached to the outer side of the linear actuator 20. In addition, a cable guide 201 is present on the front face of the linear actuator 20 and leads to a plug connection 203, to which the current and signal supply of the linear actuator 20 is connected.

An indicator device 206 (shown schematically) is further disposed on the front face of the linear actuator 20 and indicates the position of the piston 24, 4 and/or of the piston rod 23, 3 of the linear actuator 20 and of the safety device 10. According to FIG. 6, the indicator device is in position U (“unlocked”), i.e. the system of linear actuator 20 and safety device 10 is in a normal operating state, in which the work space 21aa of the hydraulic cylinder 21 is pressurized and takes up the maximum volume thereof, so that neither the piston 24 of the hydraulic cylinder nor the piston 4 of the safety device makes contact with the end stops thereof (cf. FIG. 2).

The handle 202 allows the ROV to disconnect the electrical wiring of the linear actuator 20 at the plug connector 203. This cuts the power supply to the pump 27 and the relief valve 28 such that the relief valve 28 opens and the pressure in the work space 21aa of the hydraulic cylinder 21 drops. Accordingly, the pistons 4, 24 of the safety device 10 and the linear actuator 20 are pushed into the respective end stops thereof by the spring force of the spring 6 (cf. FIG. 2) and the indicator device switches to the L (“locked”) position. Subsequently, the ROV can remove the linear actuator 20 from the safety device 10 by means of the handle 204 and the quick-release fastener 2a, 22 (cf. FIG. 5) by rotating 45° counterclockwise. The handle 205 can be subsequently be used to transport the linear actuator 20.

1. A linear actuator (20) for linear actuation of a process valve, comprising:
a housing,
an electronic control unit disposed in the housing,
at least one electric drive unit disposed in the housing, and
at least one hydraulic drive disposed in the housing, wherein the hydraulic drive comprises at least one hydraulic cylinder with a piston and a piston rod, and wherein the piston rod extends outwardly through an opening of the housing,
wherein the hydraulic drive is configured to convert an electric drive power of the electric drive unit into a hydraulic drive force, generating linear movement of the piston of the at least one hydraulic cylinder in a first direction, and
wherein a linear movement of the piston of the hydraulic cylinder in a second direction opposite to the first direction is generated by a restoring force on the piston rod acting on the piston rod outside the housing.

2. The linear actuator according to claim 1, further comprising at least one relief valve which is configured to reduce the hydraulic drive force.

3. The linear actuator according to claim 1, further comprising at least one variable restrictor valve which is configured to control the reduction of the hydraulic drive force.

4. The linear actuator according to claim 1, wherein the housing is filled with a pressure fluid.

5. The linear actuator according to claim 1, further comprising a pressure compensation device which is configured to cause pressure to be equalized between an environment and an interior space of the linear actuator.

6. The linear actuator according to claim 5, wherein the pressure compensation device is further configured to adjust a pressure in the interior space of the linear actuator in a range between ambient pressure and 10 bar above ambient pressure.

7. The linear actuator according to claim 1, further comprising at least one mechanical interface by way of which a safety device configured to generate the restoring force is connected to the linear actuator.

8. The linear actuator according to claim 7, further comprising a hydraulic circuit configured to load at least one spring of the safety device.

9. The linear actuator according to claim 1, wherein the at least one hydraulic cylinder has three cylinder chambers, of which one cylinder chamber is hermetically closed such that a vacuum forms upon movement of the piston rod.

10. The linear actuator according to claim 1, further comprising:
at least one sensor configured to detect the position of the linear actuator, and
an indicator device configured to indicate the position of the linear actuator on an exterior of the housing thereof.

11. A system for linear actuation of a process valve, comprising:
a linear actuator according to claim 1, and
at least one safety device, which is connected to the linear actuator by way of the mechanical interface.
